(19) United States
(12) Patent Application Publication
(10) Pub. No.: US 2014/0297426 A1
(43) Pub. Date: Oct. 2, 2014

(54) Simulating E-Commerce Campaigns

(71) Applicant: Adobe Systems Incorporated, San Jose, CA (US)

(72) Inventors: Jeffrey E. Young, San Jose, CA (US); Victor Saar, San Jose, CA (US); David Nuescheler, San Jose, CA (US)

(21) Appl. No.: 13/855,235

(22) Filed: Apr. 2, 2013

(51) Int. Cl. G06Q 30/02

(52) U.S. Cl. CPC G06Q 30/0271
USPC 705/14.67

(57) ABSTRACT

One exemplary embodiment involves receiving input during a simulation of a website, the input providing a test value for a user characteristic associated with simulated use of the website, the website having a configuration to provide an e-commerce service and personalized content based on the user characteristic. The embodiment further involves determining the personalized content according to the configuration based at least in part on the test value for the user characteristic and rendering the personalized content on a simulated web page of the website during the simulation.

### FIELD

This disclosure relates generally to computer software and more particularly relates to the creation, modification, use, and distribution of electronic content.

### BACKGROUND

A web site hosted by a web server provides one or more web pages to requesting users over a network. The web pages may be associated with an e-commerce service where users may browse, shop for and purchase items. These web pages may include a variety of content such as advertisements, media, text, and/or other types of electronic content. An author of the web site may provide the content to be included in the web pages. For example, the author may access a web server hosting the web site to provide the content and/or otherwise define the web pages of the web site. Additionally, the author may promote the sale of the items available via the e-commerce service by offering the items at a discount from time to time. For example, the author may promote the sale of an item by discounting the price of the item, discounting the cost to ship the item, offering a discount when purchasing multiple items, and/or any other promotional scheme to promote the sale of an item.

In some instances, the content included in the web page may be personalized based on a variety of factors. For example, the content of a web page may be personalized based on a known information about the particular user who is accessing the web page. The web page may include content personalized specifically for the user such as advertisements, media, news, and/or other electronic content targeted for the user. A user may request to access the web site from a client device by manipulating one or more user interfaces rendered on a display associated with the client device. In response, the client device may receive web pages that include personalized content specifically for the requesting user.

### SUMMARY

Disclosed are embodiments that relate to simulation of a website and/or associated promotional content. One embodiment involves receiving input during a simulation of user characteristics associated with user behavior on a website, the input providing a test value for a simulated user characteristic associated with use of the website, the website having a configuration to provide an e-commerce service and personalized content based on the simulated user characteristic. The embodiment further involves determining the personalized content according to the configuration based at least in part on the test value for the user characteristic and rendering the personalized content on a web page of the website during the simulation.

These illustrative features are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 is a block diagram depicting exemplary computing devices in an exemplary computing environment for implementing certain embodiments.

FIG. 2 is an exemplary embodiment of a first user interface rendered on a display associated with an author device.

FIG. 3 is an exemplary embodiment of a second user interface rendered on the display associated with the author device.

FIG. 4 is an exemplary embodiment of a third user interface rendered on the display associated with the author device.

FIG. 5 is an exemplary embodiment of a fourth user interface rendered on a display associated with the author device.

FIG. 6 is a flow chart illustrating an exemplary method for simulating personalized promotional content on an author device of a web page based at least in part on user characteristics.

FIG. 7 is a flow chart illustrating an exemplary method for facilitating a request for simulating personalized promotional content of a web page based at least in part on shopping cart data associated with a user.

### DETAILED DESCRIPTION

Disclosed are embodiments for simulating promotional content provided by a website. Simulating promotional content allows an author of the website to preview promotional content that is personalized for each user or user experience that would otherwise be difficult to simulate because the user characteristics and user interactions are difficult to replicate by an author testing the website. For instance, simulating the personalized promotional content may be advantageous for the author who would not have to impersonate the users and/or perform a number of end-user interactions. As a specific example, it may be very time consuming for an author to add 10 items to a shopping chart on a website to test that appropriate promotional content is displayed to users who have 10 or more items in his or her shopping cart.

A simulation panel can be used to facilitate simulation of user attributes, values that are based on user interactions, and other user characteristics. In one embodiment, an author may manipulate a simulation panel rendered on a display of the author device to provide user characteristics (e.g., specify by entering a value of 10 that there are 10 items in a shopping cart) from which to deliver the personalized promotional content that would be surfaced to an end user that exhibits those user characteristics. The user characteristics may include user attributes such as age, gender, clothing size, shoe size, purchase histories, and/or other user specific attributes. Additionally, the user characteristics also include information related to the user's interaction with a web site, such as the web site associated with the e-commerce service. User characteristics may include any information related to a user's shopping cart that may accumulated during the user's interaction with the web site associated with the e-commerce service. The information related to the user's shopping cart includes item identifiers for items added to the shopping cart, a price for each item in the shopping cart, a quantity of items in the shopping cart, a total price of all items in the shopping cart, and/or any other information related to the shopping cart.

The author may manipulate the user characteristics in the simulation panel and a simulation application executed on the author device delivers a web page from the user perspective based on the user characteristics. For instance, the author may provide test values for the user characteristics to simulate the effect of the values on the personalization of the promotional content rendered on the web page.

The author of the web site associated with the e-commerce service may provide the promotional content on one or more web pages to promote the sale of items available via the e-commerce service. For example, the promotional content may include item discounts, shipping discounts, and/or other types of promotions to promote the purchase of items by end users. The end users may be potential customers interacting with an e-commerce service who shop for, browse and/or purchase items via the e-commerce service. The author may further provide targeted promotional content to the end users by personalizing the promotional content. In some instances the personalized promotional content may be based on characteristics associated with the end user such as user profile information, purchase histories, browsing histories, and/or other user characteristics. Additionally, the personalized promotional content may be based on user interactions with the e-commerce service website. For example, the promotional content may be simulated based on the test content of a shopping cart associated with the e-commerce service. A shopping cart stores items intended for purchase while the customer browses other items available via the e-commerce service. The author of the web site may view the personalized promotional content generated based on the simulated shopping cart data of a customer. Simulating the personalized promotional content may allow the author to adjust and verify the personalization of the promotional content. For example, the author may adjust any associations between the available promotional content and the user characteristics to affect the degree of personalization of the promotional content surfaced to the end users.

The author of the web site may provide personalized promotional content on the web pages to promote the sale of the items available via the e-commerce service. For example, the promotional content may include advertisements, sales information, discount notifications, and/or other campaigns to promote the sale of items. In one embodiment, the end users may select items for purchase by adding one or more items to the shopping cart and continue with a checkout process to complete the purchase transaction. Personalized promotional content may be determined from the shopping cart data and surfaced to the end user to promote the sale of the items in the shopping cart or other items available via the e-commerce service.

The promotional content may be personalized based on user characteristics related to an interaction with the website, such as the content of the shopping cart data. For example, the shopping cart data may include an item identifier for each item in the shopping cart, a price of each item in the shopping cart, a total price of all items in the shopping cart, and/or other information related to the shopping cart. The promotional content may be personalized based on specific items in the shopping cart, a combination of items in the shopping cart, a number of items in the shopping cart, a price of each item in the shopping cart, a total price of all items in the shopping cart, and/or any other shopping cart data. In one embodiment, a web service associated with a web server device that provides the web pages also provides the personalized promotional content in conjunction with the web pages based at least in part on the shopping cart data. In another embodiment, a browser and/or other client side application being implemented on the client device may determine the shopping cart data and then request the personalized promotional content from the web server to include on the web page based on the shopping cart data. In yet another embodiment, a browser and/or other client side application being implemented on the client device may determine the shopping cart data and then provide the personalized promotional content to include on the web page based on the shopping cart data.

An author of the web site may draw associations between the shopping cart data and the promotional content to include in the web page for personalization. For example, the promotional content may be a discount as previously discussed. The author may indicate that a particular discount be surfaced to the end user based on the content of the shopping cart associated with the user. Associations between shopping cart data and other website characteristics with promotional content can be defined in any suitable way. In one embodiment, such associations are defined using one or more segments. The term “segment” as used herein refers to traits defined by the author that correspond with user characteristics In one aspect, a metadata associated with the advertisement may include segments that associate user characteristics with the respective advertisement. To this end, the author may access a segment editor service being implemented on the web server device to define one or more segments and associate the segments with the promotional content. For example, the segment editor service provides for the author to define segments for all the available promotional content. In one embodiment, a segment may correspond to a listing of user-specific characteristics for personalizing the web pages provided to the user. For example, the segments associated with the promotional content may correspond to user-specific characteristics such as interests, purchasing histories, consuming patterns and/or other characteristics. Additionally, the segments may also correspond to characteristics of a shopping cart associated with the user.

Having defined the segments for the content to be included in the web page, the author may then view the web pages as they would appear from the perspective of an end user belonging to the simulated segment. To this end, a simulation application implemented on the author device allows the author to specify particular segments to simulate and preview the personalized promotional content generated based on the simulated segments. In one embodiment, the author may wish to preview the personalized promotional content generated based on the associations between the segments and the content. Previewing the personalized content allows the author to verify, adjust, remove, and/or otherwise modify the degree of personalization. For example, the author may indicate one or more characteristics of a shopping cart via a user interface rendered on a display associated with an author device. Additionally, the author may indicate other user-specific characteristics via the user interface. In response, the simulation application identifies the segments based on the indicated user-specific characteristics and determines the promotional content to be included in the web page based at least in part on the shopping cart data. The web page is then refreshed and/or surfaced to the author device that includes the personalized promotional content.

These illustrative examples are given to introduce the reader to the general subject matter discussed here and are not intended to limit the scope of the disclosed concepts. The following sections describe various additional embodiments and examples with reference to the drawings in which like numerals indicate like elements.

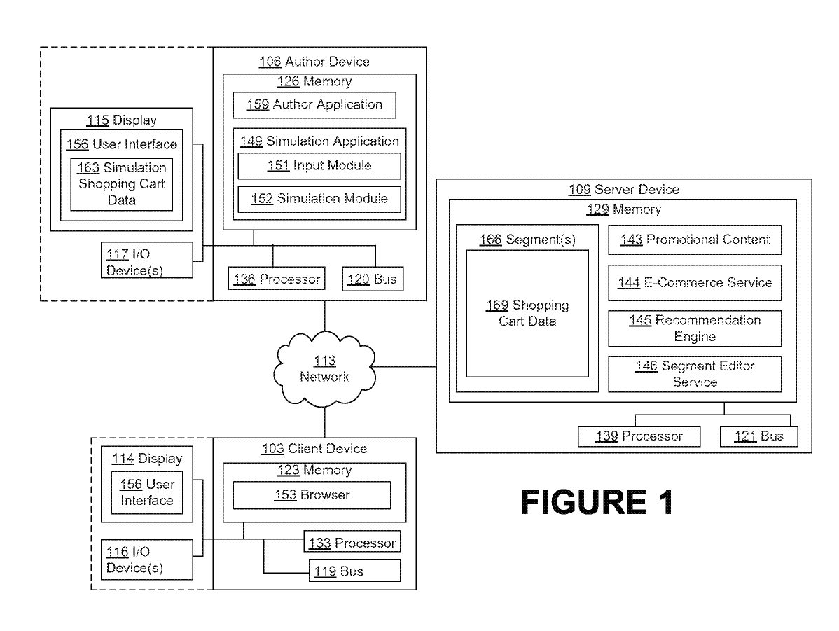

FIG. 1 depicts an exemplary computing environment for simulating, on an author device, personalized promotional content based at least in part on user characteristics as described herein. The methods and systems disclosed herein are also applicable on other computing systems and environments. The environment shown in FIG. 1 includes a wired or wireless network 113 connecting various devices 103, 106, and 109. In one embodiment, the network 113 includes the Internet. In other embodiments, other networks, intranets, or combinations of networks may be used. Alternative configurations are possible.

As used herein, the term “device” refers to any computing or other electronic equipment that executes instructions and includes any type of processor-based equipment that operates an operating system or otherwise executes instructions. A device will typically include a processor that executes program instructions and may include external or internal components such as a mouse, a CD-ROM, DVD, a keyboard, a display, or other input or output equipment. Examples of devices are personal computers, digital assistants, personal digital assistants, cellular phones, mobile phones, smart phones, pagers, digital tablets, laptop computers, Internet appliances, other processor-based devices, and television viewing devices. Exemplary devices 103 and 106 are respectively used as special purpose computing devices to provide specific functionality offered by their respective applications and by the interaction between their applications. As an example, client device 103 is shown with a display 114 and various input/output devices 116. Additionally, author device 106 is shown with a display 115 and various input/output devices 117. A bus, such as bus 119 and bus 120, will typically be included in a device as well. Additionally, a bus such as bus 121 will also typically be included on the server device 109.

As used herein, the term “application” refers to any program instructions or other functional components that execute on a device. An application may reside in the memory of a device that executes the application. As is known to one of skill in the art, such applications may be resident in any suitable computer-readable medium and execute on any suitable processor. For example, as shown the devices 103, 106, and 109 each have a computer-readable medium such as memory 123, 126 and 129 coupled to a processors 133, 136, and 139 that execute computer-executable program instructions and/or accesses stored information. Such processors 133, 136 and 139 may comprise a microprocessor, an ASIC, a state machine, or other processor, and can be any of a number of computer processors. Such processors include, or may be in communication with, a computer-readable medium which stores instructions that, when executed by the processor, cause the processor to perform the steps described herein.

As used herein, the term “service” refers to an application that listens for or otherwise waits for requests or a device that provides one or more such applications that listens for or otherwise waits for requests. Server device 109 is an example of a device implementing a service. A “server device” may be used to provide content 143 via web pages to devices such as the client device 103 and the author device 106. For example, the server device 109 may include an e-commerce service 144, a recommendation engine 145, and a segment editor service 146

A computer-readable medium may include, but is not limited to, an electronic, optical, magnetic, or other storage device capable of providing a processor with computer-readable instructions. Other examples include, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

In FIG. 1, client device 103 includes a memory 123 that includes a browser 153 and/or other components. The browser 153 may render a user interface 156 on the display 114. In one embodiment, the user interface 156 may include one or more web pages provided by the server device 109 that include personalized promotional content 143. For example, the content 143 may be personalized based at least in part on shopping cart data accumulated while the user interacts with the e-commerce service 148 to browse for items. Additionally, the user interface 156 may include shopping cart information for a user browsing for and/or shopping for items via the e-commerce service 148.

The author device 106 includes a memory 126 that includes an author application 159, a simulation application 149 and/or other components. The author application 159 may be a browser that renders a user interface 156 on the display 115. For example, the author application 159 may render one or more user interfaces 156 provided by the segment editor service 146 to define segments 166 and manage associations between segments 166 and promotional content 143.

The simulation application 149 may be received by the author device 106 from the server device 109 and is configured to simulate, for the author on the author device 106, promotional content 143 included on web pages provided by the server device 109 from a perspective of an end user accessing the web pages from a client device 103. For example, the author may desire to preview the personalized promotional content that will be dynamically generated by the server device 109. Simulating the web pages to preview the personalized promotional content 143 allows the author to modify and/or otherwise review the degree of personalization of the personalized promotional content 143.

The simulation application 149 may include an input module 151 and a simulation module 152 as shown in FIG. 1. Input module 151 may be configured to receive input providing one or more test values for one or more user characteristics for simulating personalized promotional content on a simulation of a web page. The input module 151 may be configured to render a simulation panel for receiving the input providing new test values, as well as changes to test values already received. Some or all of the test values may be received as input or some or all values may be automatically determined. A simulation panel provided by an input module may be separate from a rendering of a simulation of a web page. For example, the web page may be displayed on one side of a browser window and the simulation panel may be displayed on the other side of the browser window.

The simulation module 152 may be configured to render a simulation of one or more web page of a website. The simulation module 152 may be configured to identify personalized promotional content to include in the simulation of the web page. For example, a simulation module 152 may receive one or more test values for one or more user characteristics from input module 151 and use those values to identify personalized promotional content. Personalized content may be identified based on a segment associated with particular user characteristics. The simulation module 152 may additionally or alternatively be configured to dynamically refresh a personalized promotional content portion of the simulation of the web page to include identified personalized promotional content.

In one embodiment, the author may simulate the dynamic web pages provided by the server device 109 from the author device 106. For example, the author may provide simulation shopping cart data 163 via the user interface 156. In response, the simulation application 149 simulates a web page that includes personalized promotional content 143 based at least in part on the simulation shopping cart data 163. The simulation application 149 then provides the web page with personalized promotional content 143 to the author application 159 that is then rendered on the display 115 of the author device 106.

The server device 109 includes a memory 129 that includes one or more segments 166, promotional content 143, e-commerce service 144, the recommendation engine 145, the segment editor service 146, and/or other components. In one embodiment, the segments 166 correspond to one or more user-specific characteristics associated with users that access the web pages provided by the server device 109. For example, each segment 166 may include one or more traits that correspond to a respective user-specific characteristic. A user-specific characteristic may be an age, a gender, a pattern of purchasing items, a pattern of consuming content, and/or other characteristics associated with an end user. Additionally, the segment 166 also includes shopping cart data 169 that may be specific to the user. For example, the shopping cart data 169 may include characteristics associated with a shopping cart such as item identifiers, item quantities, item prices, and/or any other information associated with a shopping cart in an e-commerce environment. In one embodiment, the segments 166 related to the shopping cart data 169 may specify particular items, a number of items, a combination of specific items, a total price, and/or any other traits associated with the shopping cart data 169.

The e-commerce service 144 is executed in order to facilitate the online purchase of items over the network 113. The e-commerce service 144 also performs various backend functions associated with the online presence of a merchant in order to facilitate the online purchase of items. For example, the e-commerce service 144 generates web pages or other types of network content that are provided to client devices 103 for the purposes of selecting items for purchase, rental, download, lease, or other form of consumption as will be described.

The recommendation engine 145 is executed in order to provide recommended items for purchase by the customer. The recommended items may be based on a variety of factors such as user purchase history, items of the same category, items within the same price range, items by a same manufacturer, and/or other recommended items. Additionally, recommended items may be based on associations drawn between items by an author of the web site and/or the provider of the e-commerce service 144. For example, certain items available for purchase via the e-commerce service 144 may be associated with other items for recommendation when the other items are purchased. The recommendation engine 145 may also provide recommended items based on other users' purchase histories. For example, the recommendation engine 145 may provide a first user who purchased a first item with recommended items based on what other users purchased who also purchased the first item. The recommendation engine 145 may employ these and other approaches to generate and provide one or more recommended items for purchase.

The segment editor service 146 provides for the author to associate segments 166 with promotional content 143. In one embodiment, the segment editor service 146 may provide a user interface 156 that is rendered on the display 115 of the author device 106. The author may then provide one or more segments 166 via the user interface 156. For example, the author may provide keywords, unique identifiers, formulas, and/or otherwise indicate the segments 166. As an example, the author may provide a formula to define a segment 166 that corresponds to user characteristics such as an age of the user, a keyword to define a segment 166 that corresponds to a season, and/or a unique identifier to define a segment 166 that corresponds to a gender.

Additionally, the author may provide segments 166 that correspond to the shopping cart data 169. For instance, the author may define the segments 166 with characteristics associated with the shopping cart data 169 such as, one or more items available for purchase via the e-commerce service 148, a total number of items included in the shopping cart, a total price of all items included in the shopping card, and/or other information related to the shopping cart. In one embodiment, the author may define the segments 166 by browsing one or more web pages generated by the e-commerce service 144 to select the specific items available for purchase for defining the segments 166.

Having provided the segments 166, the author then associates the segments 166 with promotional content 143. In one embodiment, the author may identify promotional content 143 previously stored in the memory 129 of the server device 109. In this embodiment, the author may access the previously stored promotional content 143 via the user interface 156 and associate the segments 166 with the previously stored promotional content 143. For example, the promotional content 143 may include discounts such as a percentage discount, a price discount, a shipping discount, and/or other discount for the item being purchased by the customer or another item. In another embodiment, the author may provide new promotional content 143 to be stored in the memory 129 of the server device 109. In this embodiment, the author may provide the new promotional content 143 via the user interface 156 and associate the segments 166 with the new promotional content 143. For example, the new promotional content 143 may include item discounts, shipping discounts, and/or other types of discounts. Additionally, the new promotional content 143 may be related to discounts for other items such as recommended items based on the item purchased by the customer. In one embodiment, the author may invoke the recommendation engine 145 to generate recommended items for a purchased item and include discounts for the purchase of the recommended items in the promotional content 143.

The segments 166 may be stored in a metadata of the promotional content 143 to indicate an association between the segments 166 and the promotional content 143. For example, the author may draw the association to create personalized promotional content 143 for users associated with specific shopping cart data 169. As an example, the personalized promotional content 143 may include advertisements for recommended items, discounts for purchasing additional items, shipping discounts for purchasing a certain amount of items, and/or other discounts. In some embodiments, the personalized promotional content 143 may be associated with a campaign to promote the sale of a particular item, improve sales via the e-commerce service 144, and/or other marketing campaigns.

Additionally, the segment editor service 146 may also enable the author to edit, remove, and/or otherwise manipulate previously associated segments 166. For example, the author may access previously stored promotional content 143 and the segments 166 associated with the previously stored content 143 via the user interface 156. The author may then add new segments 166, modify existing segments 166, and/or otherwise manipulate the previously defined segments 166 associated with the previously stored content 143. For example, the author may add shopping cart data 169 to the previously defined segments 166.

The author on the author device 106 may then wish to simulate the personalized promotional content 143 included on web pages provided by the server device 109 from a perspective of an end user accessing the web pages from a client device 103. For example, the author may desire to preview the personalized web pages that will be dynamically generated by the server device 109. In one embodiment, the author may manipulate the user interface 156 rendered on the display 115 of the author device to request the simulation application 149 to simulate a web page. For example, the author may identify the web page to be simulated and indicate the segments 166 from which to personalize the web page. In one embodiment, one of the segments 166 indicated by the author may be the simulation shopping cart data 163 and/or a segment 166 associated with the simulation shopping cart data 163. In response, the simulation application 149 provides a web page that is personalized based on the segments 166 indicated by the author. For example, the web page includes personalized promotional content 143 based on the segments 166 indicated by the user, such as the simulation shopping cart data 163. The author may preview the web page containing personalized promotional content 143 based on the indicated segments 166 and make any adjustments, if necessary. Upon previewing, the author may transmit a request to the segment editor service 146 to edit segments 166 associated for that particular web page, modify the personalized promotional content 143 associated with the segments 166, and/or otherwise adjust the personalized promotional content 143 of the web page.

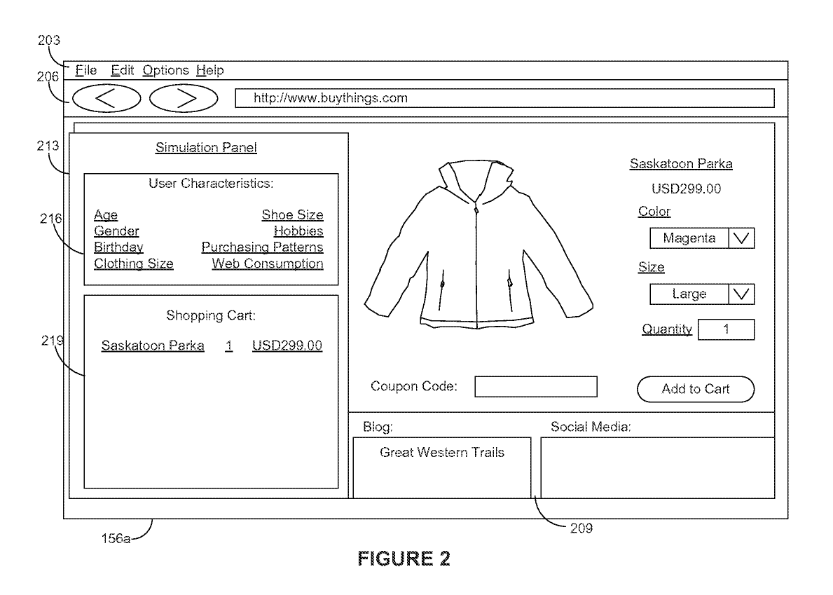

FIG. 2 illustrates one embodiment of a user interface 156, depicted herein as user interface 156a, according to certain embodiments of the present disclosure, that is rendered on the display 115 (FIG. 1) of the author device 106 (FIG. 1). In this example, the user interface 156a depicts a browser 203 with a navigation panel 206 and a web page 209 depicting an item available for purchase via the e-commerce service 144. Additionally, the user interface 156a depicts a simulation panel 213. As shown here, the simulation panel 213 includes a user characteristics box 216 and a shopping cart box 219.

In one embodiment, the web page 209 may be associated with an e-commerce service 144 (FIG. 1) that provides, to end users, one or more items available for purchase. Additionally, the web page 209 may be associated with other services such as news, streaming media, games, electronic discussion boards, and/or any other type of electronic service. In this example, the web page 209 represents a simulation to an author on the author device 106 (FIG. 1) from the perspective of a user on a client device 103 (FIG. 1). For instance, the web page 209 is rendered on the display 115 (FIG. 1) of the author device 106 (FIG. 1). The web page 209 includes a variety of components such as a blog portion, a social media portion, web page content, and/or other components. For instance, the blog portion may include one or more electronic logs that provide a variety of information such as customer stories, announcements, articles, journal entries and/or other information. The social media portion may include one or more postings from a social media platform.

Additionally, the web page 209 may depict a marketing campaign to promote the purchase of one or more items. For example, the campaign includes personalized promotional content 143 in the form of advertisements, teasers, and/or other promotions targeted for a specific user. The personalized content 143 to include in the web page 209 is based at least in part on segments 166 (FIG. 1) such as shopping cart data 169 (FIG. 1) associated with the user, as discussed above. For example, the segments 166 may be determined from a user profile accessible to the server device 109. The web server device 109 may identify the promotional content 143 with which to personalize the web page 209 from the determined segments 166. In this example, the user may be browsing items available for purchase via the e-commerce service 144 such as a parka, as shown in the web page 209. Accordingly, the shopping cart box 219 includes characteristics of the shopping cart. In this example, the characteristics include an item identifier (“Saskatoon Parka”), a quantity of the item (“1”) and a price for purchasing the item (“USD299.00”). The personalized promotional content 143 may be determined based on these characteristics of the shopping cart.

The simulation panel 213 may be provided by the simulation application 149 (FIG. 1) and rendered on top of the web page 209. In one embodiment, the web page 209 provided by the server device 109 may include the simulation application 149 as an embedded executable and/or the server device 109 provides the simulation application 149 to the author device 106 in another manner. The simulation application 149 may then be invoked via the user interface 156 and/or one of the I/O devices 117 of the author device 106. In response, the simulation panel 213 may appear as a pop-window and/or some other manner to distinguish the panel from the web page 209. The simulation panel 213 is available to the author of the web page 209 for simulating the personalized promotional content 143 included in the web page 209 for a variety of end users. In this example, the simulation panel 213 includes a user characteristics box 216 that allows the author to select and/or define various user characteristics for simulation. For instance, the user characteristics box 216 may include one or more selectable hyperlinks for defining the user characteristics. As shown in FIG. 2, the selectable hyperlinks in the user characteristics box 216 includes age, gender, birthday, clothing size, shoe size, hobbies, purchasing patterns, web consumption, and/or any other user characteristic.

Additionally, the simulation panel 213 also includes the shopping cart box 219 for the author to indicate simulation shopping cart data 163. In one embodiment, the author may indicate the simulation shopping cart data 163 in the shopping cart box 219 by providing characteristics associated with the shopping cart such as item identifiers, item quantities, item prices, and/or other information. In another embodiment, the author may indicate the simulation shopping cart data 163 by navigating one or more web pages 209 provided by the e-commerce service 144 to select the items and specify the quantities. Additionally, in another embodiment, the shopping cart box 219 may be a part of the user characteristics box 216. Any vouchers, coupons, and/or other discount counts may be included as a characteristic in the shopping cart box 219. For example, a customer may provide a coupon code earned by being a frequent customer, an active social media adopter, and/or other manner. A characteristic associated with the coupon code may appear in the shopping cart box 216 if applied by the customer on the web page 209.

Additionally, the author may have previously defined one or more segments 166 associated with the characteristics in the user characteristics box 216 and the shopping cart box 219. In particular, the author may have previously defined segments based on the shopping cart data 169 (FIG. 1). For example, the segments 166 based on the shopping cart data 169 may be names of specific items available for purchase via the e-commerce service 144, quantities of items, a total value of the items included in the shopping cart, and/or other information associated with the shopping cart. Additionally, the segments 166 may also be attributes associated with the shopping cart data 169. For example, these attributes may be related to a category of item, a season when the item is prevalent, weather when the item is prevalent, a time of day when the item is prevalent, an elevation where the item is prevalent, any sporting events related to the item, any cultural events related to the item, and/or other attributes related to the item.

As an example, the author may have previously defined segments 166 related to the item depicted in the web page 209. For instance, the previously defined segments 166 may be stored in a metadata associated with the item. These segments 166 may include a unique identifier for the item, the quantity of the item and the price of the items in the shopping cart. Thus when the author manipulates the web page 209 to select an item available via the e-commerce service 144, the shopping cart box 216 populates with the characteristics associated with the item. Similarly, when the author edits the shopping cart box 219 to edit the characteristics associated with the shopping cart, the web page 209 refreshes to reflect the segments 166 depicted in the shopping cart box 219.

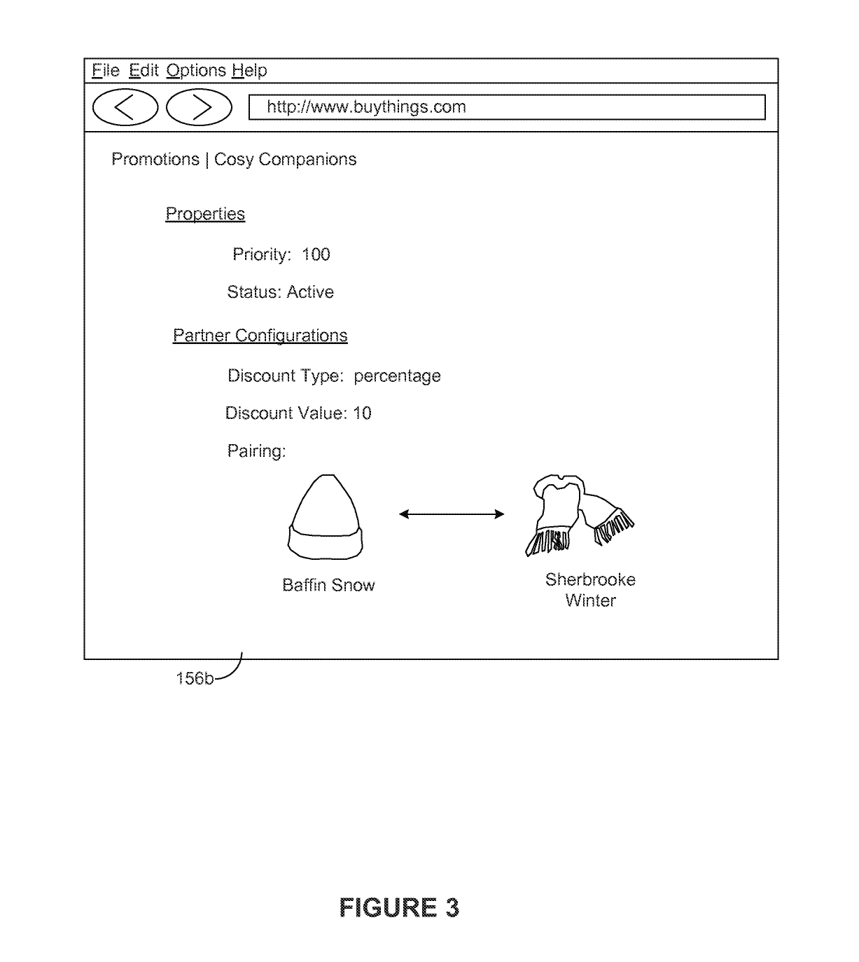

FIG. 3 illustrates one embodiment of a user interface 156, depicted herein as user interface 156b, according to certain embodiments of the present disclosure, that is rendered on the display 115 (FIG. 1) of the author device 106 (FIG. 1). In this example, the user interface 156b depicts a browser 203 with a navigation panel 206 and a web page 303 for defining promotional content 143. In this example, the author may provide a promotion entitled “Cozy Companions” and define the promotion with configurations such as a type of promotion, a magnitude of the promotion and an item pairing that triggers the promotion. For instance, the type of promotion may be a percentage discount on a purchase price of the item, a percentage discount from a shipping cost associated with the item, a value discounted from the purchase price of the item, a value discounted from the shipping cost associated with the item, and/or any other configuration for the promotion. The author may specify a value for the percentage or value, as can be appreciated. In some embodiments, the author may also assign a priority level to the promotion. For example, if more than one promotion applies, the only one promotion may be surfaced to the customer based on the priority level. Additionally, the author may include a status identifier to activate and deactivate the promotion as needed.

Additionally, the author may associate items with the promotion. For example, the promotion may offer a related item at a discounted rate when a particular item is selected for purchase. In one embodiment, the items associated with the promotion may be individually selected by the author. In another embodiment, the author may invoke the recommendation engine 145 by manipulating one more components of the user interface 156b to receive recommended items for the particular item. The author may then associate one or more recommended items with the particular item for the promotion. Accordingly, the promotional content defined by the author may be surfaced to the customers when the customer selects one of the items associated with the promotion for purchase.

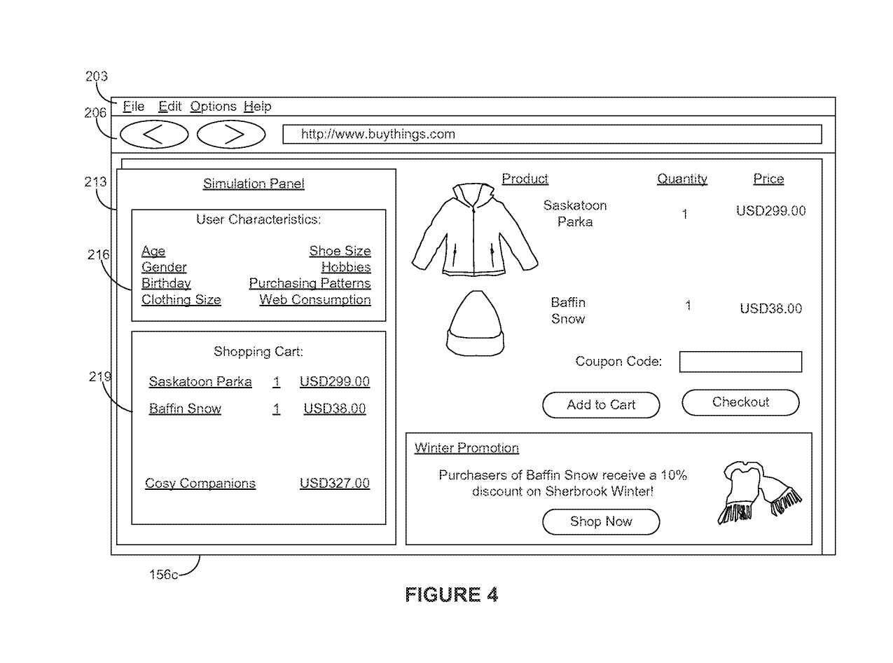

FIG. 4 illustrates one embodiment of a user interface 156, depicted herein as user interface 156c, according to certain embodiments of the present disclosure, that is rendered on the display 115 (FIG. 1) of the author device 106 (FIG. 1). In this example, the user interface 156c depicts a browser 203 with a navigation panel 206 and a web page 209 depicting an item available for purchase via the e-commerce service 144. Additionally, the user interface 156c depicts a simulation panel 213. As shown here, the simulation panel 213 includes a user characteristics box 216 and a shopping cart box 219.

In this example, the author may select another item to add to the shopping cart. For instance, the author may manipulate the shopping cart box 219 to add a new cap (“Baffin Snow”), a quantity of the new cap and a price for purchasing the new cap in the shopping cart box 219. The simulation application may dynamically refresh the web page 209 upon receiving each characteristic in the shopping cart box 219 such that the shopping cart reflects the characteristics of the shopping cart box 219. In an another embodiment, the author may manipulate the web page 209 to select the new cap (“Baffin Snow”) from one or more web pages provided by the e-commerce service 144. In response, the simulation application 149 may dynamically manipulate the shopping cart box 219 to reflect the contents of the shopping cart.

To this end, the simulation application 149 dynamically generates the web page to include personalized promotional content 143 based on the parameters of the simulation provided by the author via the simulation panel 213. For instance, the simulation application 149 provides a web page 209 that includes personalized promotional content 143 based on the characteristics as defined in the user characteristics box 216 and the shopping cart box 216. In this example, the simulation application 149 includes the promotional content 143 associated with the “Cozy Companions” defined by the author as discussed above with respect to FIG. 3. In one embodiment, the simulation application 149 refreshes the web page 209 to include the personalized promotional content 143 as the author adjusts the characteristics in the user characteristics box 216 and the shopping cart box 216. The personalized promotional content 143 may have been previously received from the server device 109 (FIG. 1) in conjunction with the web page. In one embodiment, the simulation application 149 may identify the personalized promotional content 143 to include in the simulated web page 209 by selecting from the previously received content that is stored in the memory 126 (FIG. 1) of the author device 106. Dynamically refreshing the personalized promotional content 143 allows the author to preview the effect of each characteristic in the in the user characteristics box 216 and the shopping cart box 216 and preview the varying combinations of the characteristics by forgoing repeated page loads.

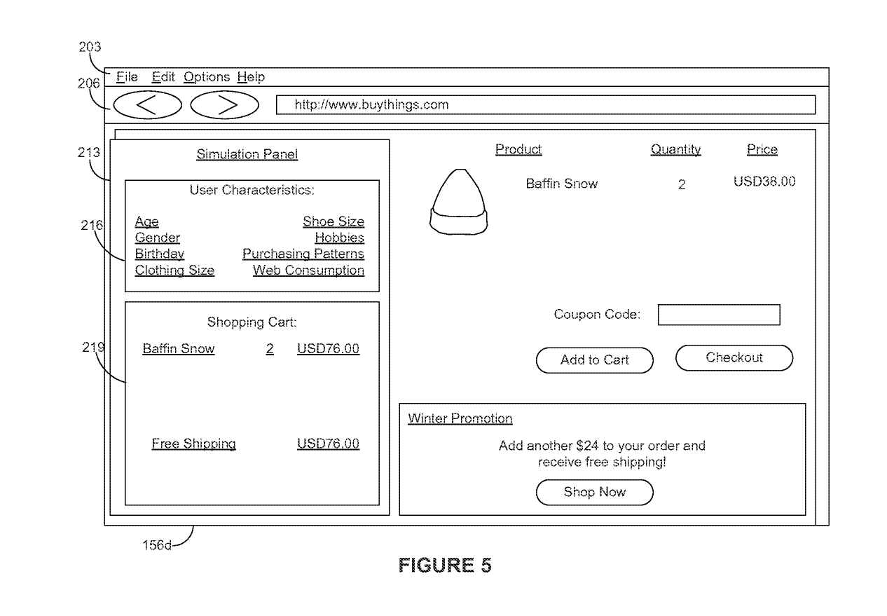

FIG. 5 illustrates one embodiment of a user interface 156, depicted herein as user interface 156d, according to certain embodiments of the present disclosure, that is rendered on the display 115 (FIG. 1) of the author device 106 (FIG. 1). In this example, the user interface 156d depicts a browser 203 with a navigation panel 206 and a web page 209 depicting an item available for purchase via the e-commerce service 144. Additionally, the user interface 156d depicts a simulation panel 213. As shown here, the simulation panel 213 includes a user characteristics box 216 and a shopping cart box 219.

The author may adjust the characteristics in the shopping cart box 216 to remove the parka and adjust the quantity of the cap. In response, the simulation application 149 refreshes the shopping cart in the web page 209 to reflect the characteristics of the shopping cart box 216. Additionally, the personalized promotional content 143 rendered on the web page 209 may be refreshed based on the characteristics of the shopping cart box 216. In this example, the characteristics of the shopping cart box 216 may be associated with a different segment 166 thereby causing different personalized promotional content 143 to be surfaced to the author. The segment 166 associated with the characteristics of the shopping cart box 216 may be related to the total price of all items in the shopping cart.

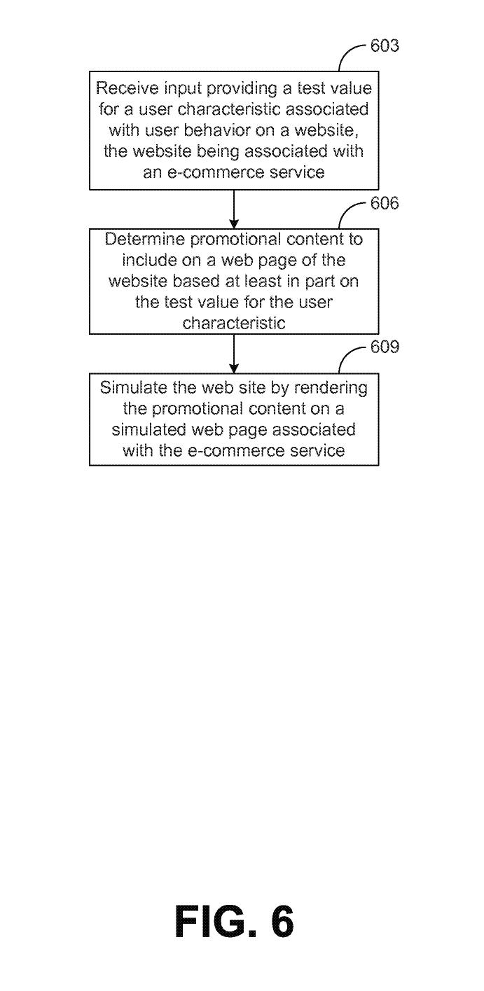

FIG. 6 is a flowchart that provides one example of the operation of a portion of the system described herein. It is understood that the flowchart of FIG. 6 provides merely an example of the many different types of functional arrangements that may be employed to implement the operation of the portion of the system as described herein. As an alternative, the flowchart of FIG. 6 may be viewed as depicting an example of steps of a method implemented by the system described herein according to one or more embodiments.

Beginning with step 603, a simulation application 149 (FIG. 1) receives input providing a test value for a plurality of user characteristics. The user characteristics comprising at least one characteristic associated with user behavior on a website associated with a e-commerce service. For example, the characteristic associated with the user behavior may include shopping cart information that may be accumulated while a user interacts with the e-commerce service, such as a simulation shopping cart data 163 (FIG. 1). In one embodiment, an author on the author device 106 may wish to simulate a web page to include personalized promotional content 143 based at least in part on the user characteristics. To this end, the author may indicate the user characteristics in a user characteristics box 216 (FIG. 2) and the simulation shopping cart data 163 in the shopping cart box 216 (FIG. 2).

Next, in step 606, the simulation application 149 determines promotional content to include on a web page of the website based at least in part on the test value for the user characteristics. In one embodiment, the simulation application 149 may first identify a plurality of segments 166 that correspond to the received test values for the user characteristics. For example, the author may have previously defined the segments 166 based on a formula and/or keywords via the segment editor service 146 (FIG. 1), as described above. Each segment 166 may be based on one or more user characteristics. Additionally, at least one segment 166 corresponds to the received simulation shopping cart data 163 or may be based at least in part on the received shopping cart data 163. For example, a segment 166 such as “parka” is based on a characteristic of the shopping cart such as an item identifier, as described above.

The simulation application 149 then identifies the promotional content 143 that are associated with the determined segments 166. For example, the simulation application 149 may have previously received promotional content 143 from the server device 109 (FIG. 1) in conjunction with the web page served up by the server device 109. The simulation application 149 may identify the personalized promotional content 143 associated with the determined segments 166 that are stored in the memory 126 (FIG. 1). In one embodiment, the author of the web page may have previously associated the segments 166 with the promotional content 143. For example, the associated segments 166 may be stored in a metadata associated with the promotional content 143 as indicated by the author.

Next, in step 609, the simulation application 149 simulates the web site by rendering the promotional content on the simulated web page associated with the e-commerce service. To this end, the simulation application 149 may cause one or more actions to dynamically render the web page that includes the personalized promotional content 143. For example, the personalized promotional content 143 portion of the web page may be refreshed on the display 115 (FIG. 1) associated with the author device 106. In one embodiment, the simulation application 149 causes the personalized promotional content 143 portion of the web page to be refreshed without reloading the web page. The author may then preview the personalized promotional content 143 as discussed above.

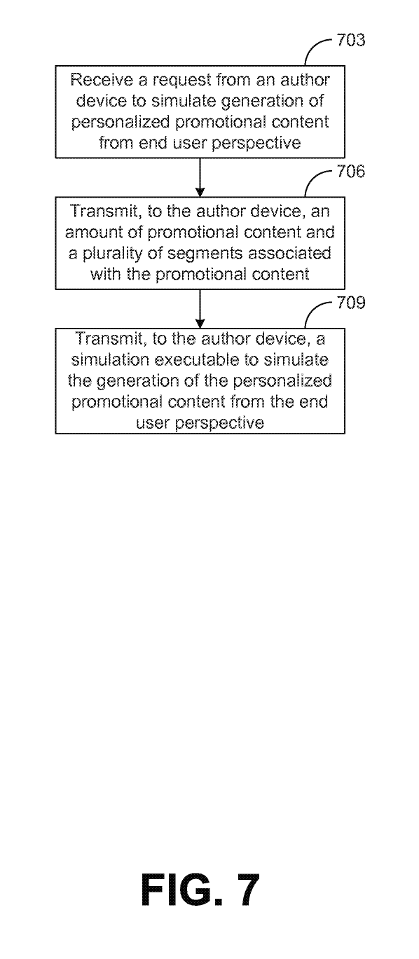

FIG. 7 is a flowchart that provides one example of the operation of a portion of the system described herein. It is understood that the flowchart of FIG. 7 provides merely an example of the many different types of functional arrangements that may be employed to implement the operation of the portion of the system as described herein. As an alternative, the flowchart of FIG. 7 may be viewed as depicting an example of steps of a method implemented by the system described herein according to one or more embodiments.

Beginning with step 703, the server device 109 (FIG. 1) receives a request from an author device 106 to simulate generation of personalized promotional content from a perspective of an end user. In one embodiment, the request may comprise a request to simulate personalization of the promotional content based at least in part on shopping cart data associated with the end user. Shopping cart data comprises one or more characteristics associated with a shopping cart in an e-commerce setting including item identifiers, quantities of items, price of items, and/or any other shopping cart related information.

In step 706, the server device 109 transmits the promotional content 143 (FIG. 1) and a plurality of segments (FIG. 1) associated with the promotional content 143 to the author device. The promotional content 143 may include advertisements and other marketing campaigns to promote the sale of items offered via an e-commerce service 144 (FIG. 1). The promotional content 143 may include item discounts and shipping discounts on items in the shopping cart of the user and/or other items related to the shopping cart of the user. Additionally, each of the promotional content 143 is associated with segments 166 that describe the characteristics of the shopping cart. For example, the segments 166 may correspond to one or more combinations of the characteristics of the shopping cart.

Next, in step 709, the server device 109 transmits a simulation executable (i.e., a simulation application 149) to the author device 106 to be implemented on the author device for simulating the generation of the personalized content. To this end, the simulation executable receives an amount of simulation shopping cart data and personalizes promotional content based on the received simulation shopping cart data. For example, the simulation executable may identify segments 166 that correspond to the received simulation shopping cart data 163 and identify promotional content 143 that are associated with the identified segments 166. The simulation executable may then dynamically render the promotional content 143 that is personalized based on the simulation shopping cart data 163 on a display associated with the author device.

### General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A method comprising:
receiving input during a simulation of user characteristics associated with user behavior on a website, the input providing a test value for a simulated user characteristic associated with simulated use of the website, the website having a configuration to provide an e-commerce service and personalized content based on the simulated user characteristic;
determining the personalized content according to the configuration based at least in part on the test value for the simulated user characteristic, wherein the determined personalized content is different for different test values for the simulated user characteristic; and
rendering the personalized content on a web page of the website during the simulation;
wherein the receiving, determining, and rendering are performed via a processor of an author device.

2. The method of claim 1 further comprising receiving additional input providing a second test value for the simulated user characteristic, determining revised personalized content based on the second test value for the simulated user characteristic, and rendering the revised personalized content on the web page of the website during the simulation.

3. The method of claim 1 further comprising providing a graphical interface displaying the web page during the simulation and separately displaying a portion for receiving the input providing the test value for the simulated user characteristic.

4. The method of claim 1 wherein the input is received as a change to a displayed item on the web page.

5. The method of claim 1 wherein the input is received as a change to a displayed item on the web page during the simulation, wherein the displayed item cannot be directly changed during end-user-use of the web page.

6. The method of claim 1 wherein the simulated user characteristic is a shopping cart characteristic.

7. The method of claim 1, further comprising:
receiving additional values for additional simulated user characteristics;
determining, based at least in part on the additional values, revised personalized content; and
dynamically refreshing the personalized content in the simulated web page with the revised promotional content.

8. The method of claim 1, wherein the simulated user characteristics are defined by a plurality of segments that are each associated with the personalized content.

9. The method of claim 1, wherein the simulated user characteristics are received from an author device associated with an author of the web page.

10. A system comprising:
a processor for executing instructions stored in computer-readable medium on one or more author devices,
the application comprising one or more modules, the modules comprising:
an input module configured to receive input providing a test value for a simulated user characteristic for simulating personalized promotional content on a web page;
a simulation module configured to render the web page, identify the personalized promotional content to include in the web page based at least in part on the received simulated user characteristic, and dynamically refresh a personalized promotional content portion of the web page to include the identified personalized promotional content.

11. The system of claim 10, wherein the input module is configured to render a simulation panel for receiving the input providing the test value, the simulation panel separate from a rendering of the web page.

12. The system of claim 10, wherein the simulation module is configured to identify the personalized content by:
determining one or more segments based at least in part on the simulated user characteristic; and
identifying the personalized promotional content associated with the one or more segments.

13. The system of claim 12, wherein the promotional content was previously associated with the one or more segments.

14. The system of claim 10, wherein the test value is for shopping cart data that cannot be changed to the test value through direct interaction with the web page.

15. The system of claim 14, wherein the shopping cart data is a total value of all items in the shopping cart.

16. A non-transitory computer-readable medium on which is encoded program code, the program code comprising:
program code for receiving, at a server device, a request, from an author device, to provide personalized promotional content from an end user perspective based at least in part on simulated user characteristics;
program code for transmitting, to the author device, promotional content and a plurality of segments associated with the promotional content; and
program code for transmitting, to the author device, a simulation executable to simulate the simulated user characteristics for generation of the personalized promotional content from the end user perspective.

17. The non-transitory computer-readable medium of claim 16, further comprising:
program code for receiving, at the server device, a request from the author device to manage the segments associated with the promotional content; and
program code for providing, to the author device, a user interface for managing the segments, the segments at least comprising characteristics related to the shopping cart data.

18. The non-transitory computer-readable medium of claim 16, wherein the simulation executable is configured to:
receive, at the author device, the simulated user characteristics, the simulated user characteristics comprising data related to interaction with the e-commerce service;
determining, at the author device, an item of personalized promotional content associated with the received simulated user characteristics; and
dynamically rendering, on a display associated with the author device, the item of personalized promotional content based at least in part on the simulated user characteristics.

19. The non-transitory computer-readable medium of claim 18, wherein determining the promotional content associated with the received simulated user characteristics comprises:
identifying, at the author device, the segments that correspond with the received simulated user characteristics; and
identifying, the author device, the promotional content associated with the identified segments.

20. The non-transitory computer-readable medium of claim 16, wherein the simulation executable is embedded in a browser.
